(19) United States
(12) Patent Application Publication
(10) Pub. No.: US 2012/0124126 A1
(43) Pub. Date: May 17, 2012

(54) CONTEXTUAL AND TASK FOCUSED COMPUTING

(75) Inventors: Mark Alcazar, Seattle, WA (US); Matthew Bret MacLaurin, Woodinville, WA (US); Oscar E. Murillo, Redmond, WA (US); Benjamin William Vanik, Seattle, WA (US)

(73) Assignee: Microsoft Corporation, Redmond, WA (US)

(21) Appl. No.: 12/947,833

(22) Filed: Nov. 17, 2010

(51) Int. Cl. G06F 17/30; G06F 15/16

(52) U.S. Cl. 709/203; 707/793; 707/749; 707/741; 707/E17.002

(57) ABSTRACT

Concepts and technologies are described herein for contextual and task-focused computing. In accordance with the concepts and technologies disclosed herein, a discovery engine analyzes application data describing applications, recognizes tasks associated with the applications, and stores task data identifying and describing the tasks in a data storage location. The task data is searchable by search engines, indexing and search services, and task engines configured to provide tasks to one or more client devices operating alone or in a synchronized manner, the tasks being provided on demand or based upon activity associated with the one or more client devices. A task engine receives or obtains contextual data describing context associate with the client devices and/or social networking data associated with one or more users of the client devices. Based upon the contextual data and/or the social networking data, the task engine identifies one or more relevant tasks and provides to the client devices information for accessing the relevant tasks, or packaged data corresponding to the relevant tasks.

### BACKGROUND

Software packages and/or applications typically include a number of functions and/or types of functions that the software or application developers bundle together due to their perceived usefulness or popularity. Users may purchase software or applications to access particular functionality of interest or utility. The users may not be interested in many of the functions included with the applications of software, but may be required to purchase or access the entire package or bundle of functionality to access the software or application.

Similarly, at any particular time there may be various applications and software packages that provide the same or similar functionality, though some of the applications or software may be provided by various vendors. Certain applications or software packages may be popular because of the collection of functionality provided by the applications, while other less popular applications provide certain functionality in a similar or even superior manner.

It is with respect to these and other considerations that the disclosure made herein is presented.

### SUMMARY

Concepts and technologies are described herein for contextual and task-focused computing. According to some embodiments of the concepts and technologies disclosed herein, a discovery engine collects application data that indicates functionality provided by applications. The discovery engine is configured to identify discrete tasks, corresponding to particular functionality of the applications, that can be provided individually to users on-demand. Thus, users no longer need to purchase or access entire applications or software packages. In some embodiments, the applications are configured to declare tasks provided by the applications, which can allow the tasks to be exposed to users in a more streamlined manner. Rather, users can access discrete tasks relevant to particular activities occurring at devices associated with the users. Additionally, users can access tasks provided by a number of vendors and can choose one or more tasks that satisfy the users' needs.

According to one aspect, application data corresponding to applications and/or software is generated. The application data is provided to or retrieved by the discovery engine. The discovery engine analyzes the application data to identify functionality provided by the applications. The discovery engine also generates, organizes, categorizes, and stores task data that describes and identifies tasks associated with the applications, the tasks corresponding to the identified functionality of the applications. The task data is stored in data store such as a database or server that is accessible to a task engine.

According to another aspect, the task engine obtains contextual data indicating activities at one or more client devices. Based upon the contextual data, the task engine searches or queries the task data to identify tasks that are expected to be relevant to the one or more client devices. The relevancy of the tasks can be determined based upon activities occurring at the client devices, files accessed at the client devices, activity history associated with the client devices, interactions between the client devices, and/or the like. The task engine also can obtain or access social networking data associated with a user of the client device. The social networking data can be used in addition to, or instead of, the contextual data to identify tasks that are believed to be relevant to the user of the client device based upon usage, comment, review, or rating by members of the user's social networks.

According to another aspect, the relevant tasks are identified by the task engine, and packaged for presentation to or use by the client device. The task engine is configured to provide identifying information to the client such as links and the like, or to package the relevant tasks for presentation and/or consumption at the client device or another device. The task engine also is configured to determine a ranking and/or advertising scheme for the tasks based upon popularity of the tasks, advertising fees paid by vendors associated with the tasks, usage of the tasks by social network members, numbers of explicit searches for the tasks, other search or usage history of entities that have accessed the tasks, and the like. The tasks can be provided to the client device in accordance with the ranking and/or advertising scheme. Metrics associated with the tasks can be tracked and provided to one or more vendors associated with the tasks, if desired.

According to various embodiments, the client device is configured to execute a web-based operating system (OS). Thus, the client device may execute an operating system or other base program that is configured to access web-based or other remotely-executed applications and services to provide specific functionality at the client device. The client device therefore may provide various applications and services via a simple operating system or an application comparable to a standard web browser. It should be understood that the client device can execute other web-based and non-web-based operating systems, as is explained in more detail below.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an exemplary operating environment for the various embodiments disclosed herein.

FIG. 2 is a flow diagram showing aspects of a method for discovering and storing tasks associated with applications, according to an exemplary embodiment.

FIG. 3 is a flow diagram showing aspects of a method for identifying relevant tasks based upon contextual data, according to an exemplary embodiment.

FIG. 4 is a flow diagram showing aspects of a method for providing tasks based upon social networking data, according to an exemplary embodiment.

FIG. 5 is a flow diagram showing aspects of a method for packaging and providing relevant tasks, according to an exemplary embodiment.

FIG. 6 is a computer architecture diagram illustrating an exemplary computer hardware and software architecture for a computing system capable of implementing aspects of the embodiments presented herein.

### DETAILED DESCRIPTION

The following detailed description is directed to concepts and technologies for contextual and task-focused computing. According to the concepts and technologies described herein, applications can include various functionality. A discovery engine analyzes application data describing the applications, recognizes tasks associated with the applications, and stores task data identifying and describing the tasks in a data storage location. In one embodiment, the task data is searchable by search engines, indexing and search services, and task engines configured to provide tasks to client devices on demand or based upon activity associated with the client devices.

The task engine receives or obtains contextual data describing context associate with a client device. The task engine also is configured to receive or obtain social networking data associated with one or more users of the client device. Based upon the contextual data and/or the social networking data, the task engine identifies one or more relevant tasks and provides to the client device information for accessing the relevant tasks, or packaged data corresponding to the relevant tasks. The task engine also is configured to rank the relevant results based upon the social networking data, the contextual data, and/or other metrics relating to the tasks and/or vendors associated with the tasks. In some embodiments, vendors are allowed to pay for improved placement of their tasks by the task engine and/or for advertising in search results pages that are perceived by the task engine to be relevant to one or more tasks associated with the vendors. According to various embodiments, metrics and usage statistics associated with the tasks are tracked and provided to vendors.

The word “application,” and variants thereof, is used herein to refer to computer-executable files for providing functionality to a user. According to various embodiments, the applications can be executed by a device, for example a computer, smartphone, or the like. Additionally, the computer, smartphone, or other device can execute a web browser or operating system that is configured to access remotely-executed applications and/or services such as web-based and/or other remotely-executed applications. In some embodiments, the applications are provided by a combination of remote and local execution, for example, by execution of JavaScript, DHTML, AJAX, .ASP, and the like. According to other embodiments, the applications include runtime applications built to access remote or local data. These runtime applications can be built using the SILVERLIGHT family of products from Microsoft Corporation in Redmond, Wash., the AIR and FLASH families of products from Adobe Systems Incorporated of San Jose, Calif., and/or other products and technologies.

The word “tasks,” and variants thereof, is used herein to refer to a particular set, subset, or category of functionality associated with and/or provided by a particular application. Tasks also may refer to individual functions of applications. Thus, an application can include any number of tasks, wherein the tasks define individual functions of the applications and/or types, sets, or subsets of the functions associated with the applications. For example, the tasks can include particular features of applications such as a task for playback of an audio file in the case of a media playback application. Similarly, the tasks can include multiple features associated with the applications such as macros and/or other automated tasks associated with an application. These examples are illustrative, and should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for contextual and task-focused computing will be presented.

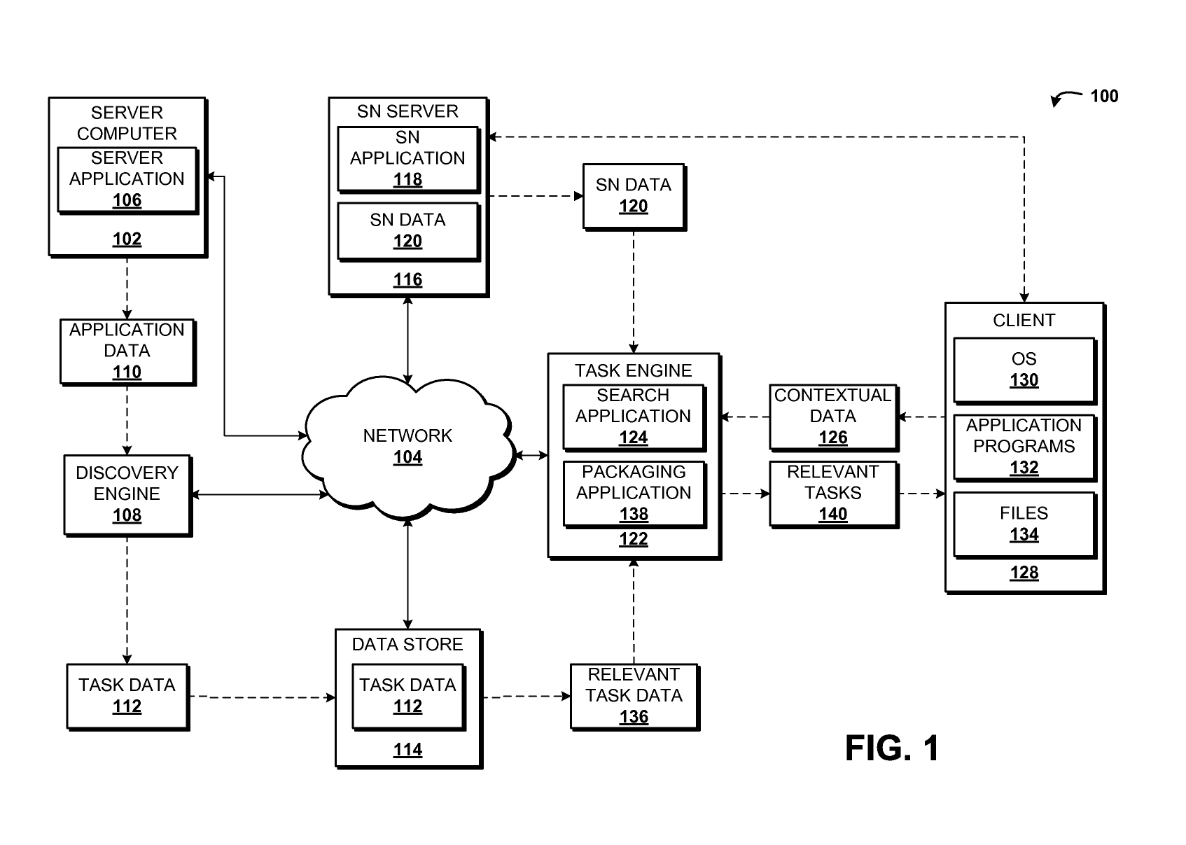

Referring now to FIG. 1, aspects of one operating environment 100 for the various embodiments presented herein will be described. The operating environment 100 shown in FIG. 1 includes a server computer 102 operating on or in communication with a network 104. According to various embodiments, the functionality of the server computer 102 is provided by a web server operating on or in communication with the Internet, though this is not necessarily the case.

The server computer 102 is configured to execute a server application 106 for providing functionality associated with the server computer 102. According to various embodiments, the server application 106 provides a mapping application for providing maps, navigation instructions, location based services, and the like. The server application 106 also can provide multimedia functionality such as, for example, video and audio streaming, video and audio playback functionality, and the like. The server application 106 also can provide tools such as photo, video, and audio editing and creation applications, word processing functionality, data backup and storage functionality, calendaring applications, messaging applications such as email, text messaging, instant messaging, and realtime messaging applications, shopping applications, search applications, and the like. The above list is not exhaustive, as the server application 106 can provide any functionality associated with the server computer 102. While the embodiments described herein include server applications 106 executing on server computers 102, it should be understood that client-centric approaches are also possible, wherein client devices execute applications that access data and/or applications hosted by the server computers 102, as described in more detail below. Thus, the above examples are exemplary and should not be construed as being limiting in any way.

According to various embodiments, the operating environment 100 further includes a discovery engine 108 operating on or in communication with the network 104. The discovery engine 108 can include a combination of hardware and software for discovering applications such as the server application 106, and identifying one or more tasks provided by the applications. In some embodiments, the discovery engine 108 identifies or receives application data 110 corresponding to the server application 106.

The application data 110 describes the server application 106 and/or functionality associated therewith. The application data 110 can be generated by the server application 106, for example via computer executable instructions that, when executed by the server computer 102, cause the server computer 102 to self-describe the server application 106 and provide or make available the application data 110. In other embodiments, one or more search engines (not illustrated) identify and describe functionality associated with the server computer 102 and/or the server application 106. The search engines generate the application data 110 and provide or make available the application data 110. Thus, it will be appreciated that the application data 110 corresponds, in some embodiments, with metadata describing the server application 106 and/or functionality associated therewith. It therefore should be understood that in some embodiments the application data 110 is generated by the server computer 102, and in other embodiments the application data 110 is generated without any involvement of the server computer 102.

The discovery engine 108 analyzes the application data 110 and identifies one or more tasks provided by the server application 106, as defined or described by the application data 110. The tasks describe particular functionality of the server application 106. For example, if the server application 106 includes photo editing functionality, the tasks provide by the server application 106 can include, but are not limited to, color balancing tasks, sharpness adjustment tasks, red-eye removal tasks, image sizing and cropping tasks, special effects tasks, blemish removal tasks, text editing tasks, blurring tasks, contrast, hue, and brightness adjustment tasks, and other tasks.

The discovery engine 108 identifies tasks provided by the server application 106, and generates task data 112. The task data 112 describes each task provided by the server application 106. In some embodiments, the discovery engine 108 also provides organization and categorization functionality for organizing and categorizing the task data 112. According to these embodiments, the discovery engine 108 is configured to organize the task data 112 according to the tasks described by the task data 112, and to categorize the task data 112 according to categories of the tasks corresponding to the task data 112.

In the above example of a server application 106 for photo editing, the discovery engine 108 can create a category of image editing tasks, wherein the image editing tasks correspond not only to the server application 106, but also to other applications provided by any number of server computers 102 (though only one server computer 102 is illustrated in FIG. 1). Thus, the discovery engine 108 can categorize and/or organize all photo editing tasks for the server applications 106 into an image editing category, for example. The discovery engine 108 can catalogue, categorize, and organize all tasks for all identified applications, and store the catalogued, categorized, and organized task data 112 at a data storage location such as the data store 114.

In addition to, or instead of, the discovery engine 108 identifying, categorizing, and/or organizing the tasks based upon the application data 110, in some embodiments, application or task developers are allowed or required to package and submit tasks and/or task packages to the discovery engine 108 for indexing, categorizing, organizing, and the like. In some embodiments, the developers author text descriptions and/or metadata describing the functionality of the tasks or task packages, the types of inputs accepted by the tasks, the types of outputs generated by the tasks, keywords associated with the tasks, limitations and/or capabilities, and the like. Additionally, in some embodiments, the server applications 106 and/or other applications can be configured to self-declare tasks provided by the applications. Thus, the application data 110 can be generated by the applications without action on the part of developers and/or the discover engine 108. Irrespective of how the application data 110 and/or the task data 112 is generated, it should be understood that the task data 112 can be stored in a searchable format such as extensible markup language (“XML”), text, and other formats.

The functionality of the data store 114 can be provided by one or more databases, memory devices, server computers, desktop computers, mobile telephones, laptop computers, other computing systems, and the like. In the illustrated embodiments, the functionality of the data store 114 is provided by a database operating in communication with the network 104. In these embodiments, the data store 114 is configured to receive and respond to queries of the task data 112 by devices configured to communicate with the network 104. It should be understood that these embodiments are exemplary.

The operating environment 100 also includes a social networking server 116 (“SN server”) operating on or in communication with the network 104. The SN server 116 executes a social networking application 118 (“SN application”) to provide social networking services to one or more users. Exemplary social networking services include, but are not limited to, the FACEBOOK social networking service, the LINKEDIN professional networking service, the YAMMER office colleague networking service, and the like. In other embodiments, social networking functionality is provided by other services, sites, and/or providers that are not explicitly known as social networking providers. For example, some web sites allow users to interact with one another via email, chat services, gameplay, and/or other means, without explicitly supporting “social networking services.” Examples of such services include, but are not limited to, the WINDOWS LIVE service from Microsoft Corporation in Redmond, Wash., among others. Therefore, it should be appreciated that the above list of social networking services is not exhaustive, as numerous social networking services are not mentioned herein for the sake of brevity.

The SN application 118 generates social networking data 120 (“SN data”) associated with one or more users. The SN data 120 describes, for example, social networking graphs associated with users, user content such as status updates, photographs, reviews, links, and the like, contact and biographical information associated with users, and the like. The SN data 120 can include, for example, information describing applications or tasks accessed by users of the social networking service, links and status updates relating to applications and tasks, combinations thereof, and the like. The SN data 120 also can include other information such as likes and dislikes, user comments, user connection requests, and the like.

The operating environment 100 also includes a task engine 122 operating on or in communication with the network 104. The task engine 122 is configured to identify tasks based upon a variety of inputs. In some embodiments, the task engine 122 executes a search application 124 for searching the task data 112. According to various embodiments, the task engine 122 receives contextual data 126 from a client 128 operating in communication with the task engine 122.

According to various embodiments, the client 128 is a personal computer (“PC”) such as a desktop, tablet, or laptop computer system. The client 128 may include other types of computing systems including, but not limited to, server computers, handheld computers, netbook computers, embedded computer systems, personal digital assistants, mobile telephones, smart phones, or other computing devices. Although not illustrated in FIG. 1, it should be understood that the client 128 can communicate with the task engine 122 via the network 104.

The client 128 is configured to execute an operating system 130. According to various embodiments the operating system 130 executed by the client 128 is a web-based operating system. In some embodiments, the client 128 is not configured or equipped to execute traditional native applications and/or programs at the client-side, and instead accesses remotely-executed applications such as web applications and/or other remote applications, and renders the application data for presentation at the client 128. In still other embodiments, the client 128 is configured to access remotely-executed applications and to execute some local code such as scripts, local searches, and the like. As such, the client 128 can be configured to access or utilize cloud-based, web-based, and/or other remotely executed applications, and to render the application data at the client 128.

In some embodiments, the 128 is further configured to execute applications programs 132. The application programs 132 can include a web browser or web-based operating system that is configured to access web-based or runtime applications, and to render the data generated by the web-based or runtime applications for use at the client 128. Thus, the application programs 132 can include one or more programs for accessing and rendering web pages, accessing and rendering applications, and/or accessing and rendering services. In some embodiments, the client 128 also is configured to execute stand-alone or runtime applications that are configured to access web-based or remote applications via public or private application programming interfaces (“APIs”). Therefore, while the word “application” and variants thereof is used extensively herein, it should be understood that the applications can include locally-executed and/or remotely-executed applications.

The contextual data 126 describes contextual information associated with the client 128. For example, the contextual data 126 identifies one or more application programs 132 being accessed or executed by the client 128 and/or one or more files 134 being accessed, edited, created, or saved by the application programs 132. The files 134 can include any type of computer data accessed via the operating system 130 and/or the application programs 132. For example, the files 134 can include, but are not limited to, documents, audio files, video files, web pages, programs, scripts, images, social networking content, spreadsheets, and the like. Furthermore, the files 134 can include an indication of a web-based or other remote resource being accessed or utilized by the client 128. Thus, the files 134 can indicate usage or access of one or more web-based or other remotely-executed applications by the client 128.

The contextual data 126 also can describe one or more actions taken entirely at the client 128. For example, the contextual data 126 may indicate movement of a cursor or pointer at the device, alphanumeric text input, clicking at a particular location or region at the client 128, and/or other movements or inputs received at the client 128. These and other inputs can prompt, for example, local execution of scripts and/or code at the client 128. These actions can be captured by the contextual data 126 and thereby passed to the task engine 122. These and other actions can be mediated by an application executed remotely or locally relative to the client 128, and therefore may be captured by the contextual data 126 not only as particular actions, but additionally, or alternatively, as specific invocation of particular functionality associated with the remote or local application, script, or code execution.

According to various embodiments, the contextual data 126 describes one or more of the files 134 and/or one or more types of files being accessed at the client 128, as well as one or more application programs 132 and/or types of application programs being executed or accessed by the client 128. The contextual data 126 is received or retrieved by the task engine 122, and used to identify tasks that are expected to be relevant to users or software associated with the client 128.

The search application 124 receives the contextual data 126 and searches the task data 112 to identify tasks that may be relevant to the client 128 based upon the contextual data 126. As mentioned above, the search application 124 can be configured to query the task data 112, though other methods of searching content including the task data 112 can be used. In an exemplary embodiment, if the contextual data 126 indicates that the client 128 is accessing a photograph, the search application 124 queries the task data 112 to identify all tasks related to image editing. Similarly, if the contextual data 126 indicates that the client 128 is accessing an audio file, the search application 124 queries the task data 112 to identify tasks related to audio files such as, for example, recording tasks, editing tasks, conversion tasks, audio processing tasks, and the like. These examples are illustrative, and should not be construed as being limiting in any way.

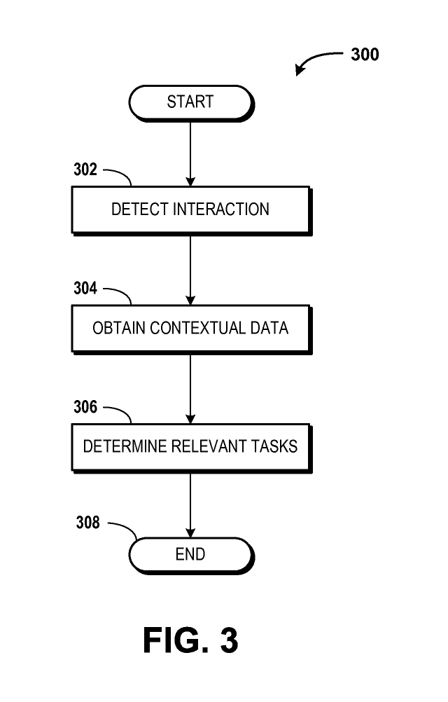

The contextual data 126 also can be provided by one or more search engines (not illustrated) in communication with or coupled to the task engine 122. In addition to determining what kind of activities are occurring at the client 128, the contextual data 126 can indicate activity associated with the client 128 over some time period, for example, during the day, the previous week, the previous month, and the like. The contextual data 126 can relate to some or all interactions at the client 128 including web searches, application or task usage, email messaging usage, map usage, and the like. An exemplary method for identifying relevant tasks based upon the contextual data 126 is illustrated and described in more detail herein with reference to FIG. 3.

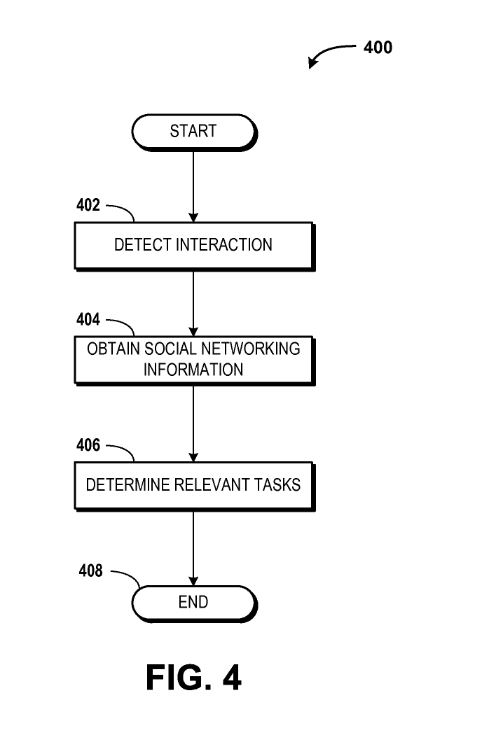

In some embodiments, the search application 124 receives or retrieves the SN data 120 in addition to, or instead of, the contextual data 126. The search application 124 uses the SN data 120 to identify tasks or applications used, consumed, reviewed, posted, commented on, or otherwise referenced by one or more members of a social network associated with a particular user, for example, a user associated with the client 128. Thus, the search application 124 can query the task data 112 to identify tasks based not only upon the contextual data 126 associated with the client 128, but also based upon one or more social networks corresponding to a user of the client 128. An exemplary method for identifying relevant tasks based upon the SN data 120 is illustrated and described in more detail with reference to FIG. 4.

In response to searching or querying the task data 112, the task engine 122 receives relevant task data 136. The relevant task data 136 identifies tasks that are relevant to the submitted query or search parameters. The relevant task data 136 can identify application tasks that are believed to be useful to the client 128 in view of the contextual data 126 and/or the SN data 120. The relevant task data 136 can identify the tasks or applications by one or more addresses, names, applications, categories, functionality descriptions, and the like. In some embodiments, application tasks are identified by one or more uniform resource locator (“URL”) addresses associated with a server application 106 associated with the application tasks. These methods of identifying the location of network resources are exemplary, and should not be construed as being limiting in any way. Other methods of identifying the location of resources on a network are known and will not be described herein for the sake of brevity.

According to some embodiments, the functionality of the task engine 122 is invoked by search engines (not illustrated) communicating with the client 128 and/or other devices or nodes. For example, the task engine 122 can be invoked by the search engines in response to receiving a query from the client 128 or another device or network node. The search engines can be configured to recognize queries that may be satisfied by one or more applications or tasks. For example, if the search engines receive a query “how do I edit a .jpeg file,” the search engines may recognize the words “edit” and “.jpeg,” and determine that the searcher is interested in .jpeg editing functionality. This determination can be used by the search engines to search the task data 112 and/or passed to the task engine 122, which can use this determination to drive a search or query of the task data 112. In this example, the search engines or the task engine 122 can query or search the task data 112 for all tasks usable to edit .jpeg files. This example is exemplary, and should not be construed as being limiting in any way.

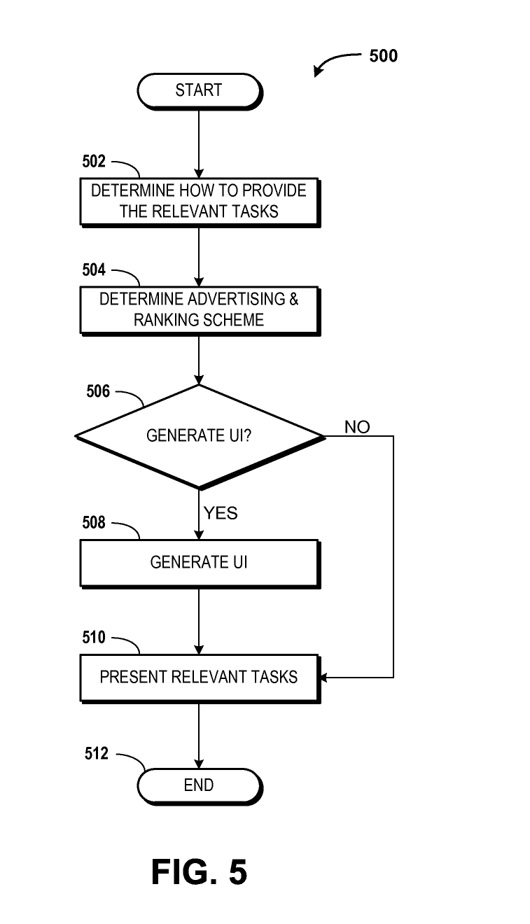

In some embodiments, the task engine 122 is configured to execute a packaging application 138. The packaging application 138 is configured to determine how to present the relevant task data 136 to the client 128. For example, the packaging application 138 determines whether the relevant task data 136 should be packaged as user interfaces (“UIs”), as links to the resources, as search results, and the like. An exemplary method for packaging the relevant task data 136 is illustrated and described in more detail below with reference to FIG. 5.

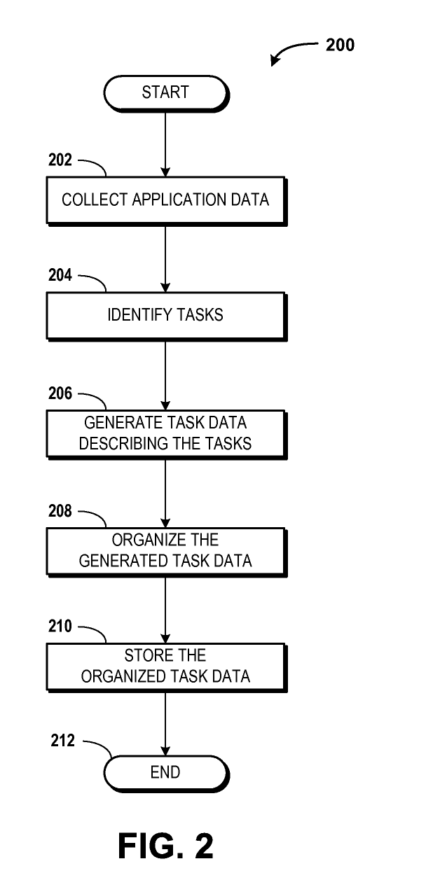

After determining how to package the relevant task data 136, the packaging application 138 provides the relevant task data 136 to the client 128 in the determined package as packaged relevant task data 140 (“relevant tasks”). In some embodiments, the relevant tasks 140 include executable code corresponding to the tasks identified by the relevant task data 136. In some embodiments, the packaging application 138 also determines how to rank the relevant task data 136, if advertising content should be generated and packaged with the relevant task data 136, and/or how to charge or credit one or more entities for use or identification of the relevant tasks 140. These and other features of the task engine 122 are described below with reference to FIGS. 2-5.

Although the search application 124 and the packaging application 138 are illustrated as components of the task engine 122, it should be understood that each of these components, or combinations thereof, may be embodied as or in stand-alone devices or components thereof operating on or in communication with the network 104 and/or the client 128. Thus, the illustrated embodiment is exemplary, and should not be construed as being limiting in any way.

FIG. 1 illustrates one server computer 102, one network 104, one discovery engine 108, one data store 114, one SN server 116, one task engine 122, and one client 128. It should be understood, however, that many implementations of the operating environment 100 include multiple server computers 102, multiple networks 104, multiple discovery engines 108, multiple data stores 114, multiple SN servers 116, multiple task engines 122, and/or multiple clients 128. Thus, the illustrated embodiments should be understood as being exemplary, and should not be construed as being limiting in any way.

Turning now to FIG. 2, aspects of a method 200 for discovering and storing tasks associated with applications will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration, and not for purposes of limiting the disclosure in any way. Operations may be added, omitted, and/or performed simultaneously, without departing from the scope of the appended claims.

It also should be understood that the illustrated methods can be ended at any time and need not be performed in their respective entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof.

For purposes of illustrating and describing the concepts of the present disclosure, the method 200 is described as being performed by the discovery engine 108. It should be understood that this embodiment is exemplary and should not be viewed as being limiting in any way. The method 200 can be performed by additional or alternative entities, or combinations thereof.

The method 200 begins at operation 202, wherein the discovery engine 108 collects the application data 110. According to various embodiments, the discovery engine 108 performs periodic searches of devices and software communicating with the network 104 to identify any applications accessible via the network 104. In other embodiments, the devices and software periodically generate the application data 110 and transmit the application data 110 to the discovery engine 108. In still other embodiments, the application data 110 is generated manually or automatically based upon analysis of devices and software accessible via the network 104.

As mentioned above, the application data 110 describes the applications accessible via the network 104. In some embodiments, the application data 110 describes all functions associated with the applications. These functions can be described or can be one or more tasks provided by the applications. Thus, the application data 110 can describe all tasks accessible via the network 104.

From operation 202, the method 200 proceeds to operation 204, wherein the discovery engine 108 parses the application data 110 to identify all tasks associated with the applications, as mentioned above. The discovery engine 108 can be configured to use various data processing methods, hardware, and software to identify the tasks. For example, the discovery engine 108 can search the application data 110 to identify actions that are prompted by input and/or actions that generate output. Such actions can be determined by the discovery engine 108 to correspond to one or more tasks. These embodiments are exemplary, and should not be construed as being limiting in any way.

From operation 204, the method 200 proceeds to operation 206, wherein the discovery engine 108 generates the task data 112 corresponding to the identified tasks. As explained above, the task data 112 describes the tasks, the location of the tasks, and any other information associated with the tasks such as computing requirements, registration information and/or requirements, application or task version numbers, availability information, capacity or file size limitations and/or requirements, combinations thereof, and the like.

The task data 112 also stores information indicating how the tasks are called, inputs required for the tasks, and/or outputs generated by the tasks. Additionally, the task data 112 can indicate other tasks or applications that are invoked by the tasks. For example, the task data 112 may indicate for a particular task that invocation of that task further requires invocation of another task such as, for example, an authentication task, a token exchange task, a media playback task, a file export task, and/or any other task. Thus, the task data 112 can describe all aspects of the tasks in a searchable data format.

From operation 206, the method 200 proceeds to operation 208, wherein the discovery engine 108 organizes the task data 112. As explained above with reference to FIG. 1, the discovery engine 108 can organize and/or categorize the task data 112 according to any desired aspects of the task data. In some embodiments, for example, the task data 112 is categorized and/or organized based upon functionality associated with the tasks corresponding to the task data 112. For example, all multimedia tasks can be stored in one category dedicated to multimedia tasks. Similarly, the multimedia tasks can be organized into a number of subcategories or other divisions based upon a type of multimedia, a type of tasks, and the like.

The categories and/or subcategories of the tasks can based upon broad or narrow definitions. For example, the tasks can be organized into a category of tasks for color balancing of images, which is considered a narrow category relative to a image processing tasks category and/or a multimedia tasks category. It therefore should be understood that the task data 112 can be organized into as few or as many categories, subcategories, and/or other divisions, based upon desires, needs, and/or preferences. It should be appreciated that a particular task may be organized or categorized in one or more ways. For example, a task may be organized or categorized based upon functionality of the task, as well as cost of the task, ease of use of the task, computing requirements of the task, authorship of the task, ratings or rankings of the task, and/or other characteristics. Thus, the examples provided herein should be understood as being illustrative, and should not be construed as being limiting in any way.

From operation 208, the method 200 proceeds to operation 210, wherein the discovery engine 108 stores the organized task data 112 in a data storage location. In some embodiments, as explained above with reference to FIG. 1, the task data 112 is stored at the data store 114. In other embodiments, the task data 112 is hosted by a task data server (not illustrated) that is configured to serve the task data 112 to requesting or searching entities. In still other embodiments, the task data 112 is stored in a memory device associated with the discovery engine 108, the task engine 122, and/or one or more other devices operating on or in communication with the network 104. The method 200 ends at operation 210.

Turning now to FIG. 3, a method 300 for identifying the relevant tasks 140 based upon contextual data 126 is described in detail, according to an exemplary embodiment. For purposes of illustration, and not limitation, the method 300 is described as being performed by the task engine 122. It should be understood that this embodiment is exemplary, and should not be construed as being limiting in any way. Furthermore, it should be understood that the functions of the task engine 122 can be provided by a stand-alone device and/or by hardware and/or software associated with other devices. In some embodiments, the functionality of the task engine 122 is provided by the operating system 130 of the client 128 and/or by execution of one or more of the application programs 132 at the client.

The method 300 begins at operation 302, wherein the task engine 122 detects an interaction at the client 128. The interaction detected by the task engine 122 can include an interaction at the client 128 with one or more files 134, an interaction with one or more application programs 132 executing at the client 128, an interaction between the client 128 and one or more remotely executed or web-based applications, and/or access or utilization of a web-based or other remotely executed application by the client 128.

As explained above, the functionality of the task engine 122 can be provided by one or more of the application programs 132 executed by the client 128. Additionally, the functionality of the task engine 122 can be provided by the operating system 130 of the client 128 and/or by execution of one or more of the application programs 132 executing at the client 128. In other embodiments, the task engine 122 is in communication with the client 128 and detects interactions at the client 128. In any event, the task engine 122 detects that the client 128 is executing one or more application programs 132, accessing or utilizing one or more web-based or remotely-executed applications, and/or interacting with one or more files 134.

From operation 302, the method 300 proceeds to operation 304, wherein the task engine 122 obtains the contextual data 126. As explained above with reference to FIG. 1, the contextual data 126 describes aspects of the interaction(s) occurring at the client 128. For example, the contextual data 126 may describe file types associated with the files 134, one or more applications or resources being accessed or utilized by the client 128, operations occurring at the client 128, the particular or types of application programs 128 executing at or being accessed by the client 128, combinations thereof, and the like. Thus, the contextual data 126 describes the types of interactions occurring at the client 128, including information indicating file types associated with the files 134 as well as other processes occurring at the client 128.

From operation 304, the method 300 proceeds to operation 306, wherein the task engine 122 identifies one or more tasks that are relevant to the contextual data 126 associated with the client 128. As explained above, the task engine 122 searches or queries the task data 112 based upon the contextual data 126 to identify tasks that are believed to be relevant to activity associated with the client 128. For example, if the client 128 is interacting with a video file, the contextual data 126 may indicate this interaction, as well as file types associated with the video file and/or other information such as, for example, the size, resolution, length, frame rate, and the like, of the video file. Based, at least partially, upon this contextual data 126, the task engine 122 can identify tasks relevant to the client 128. An exemplary method for packaging and surfacing the relevant tasks 140 to the client 128 is illustrated and described in more detail with reference to FIG. 5. The method 300 ends at operation 308.

Turning now to FIG. 4, a method 400 for identifying the relevant tasks 140 based upon social networking data 120 is described in detail, according to an exemplary embodiment. For purposes of illustration, and not limitation, the method 400 is described as being performed by the task engine 122. This embodiment is exemplary, and should not be construed as being limiting in any way. As explained above with reference to FIG. 3, the functions of the task engine 122 can be provided by a stand-alone device and/or by hardware and/or software associated with other devices. In some embodiments, the functionality of the task engine 122 is provided by the operating system 130 of the client 128 and/or by execution of one or more of the application programs 132 by the client 128.

The method 400 begins at operation 402, wherein the task engine 122 detects an interaction at the client 128. The interaction detected by the task engine 122 can include an interaction at the client 128 with one or more files 134, an interaction with one or more application programs 132 executing at the client 128, an interaction with one or more remotely executed or web-based applications, and/or access or utilization of a web-based or other remotely executed application by the client 128.

In some embodiments, the task engine 122 senses an interaction that does not occur at the client 128. For example, the operation 402 can include occurrence of an event or interaction that does not occur at the client 128. In some embodiments, the operation 402 includes generation of a friend request, receipt of a chat or instant messaging request, a status update for a member of a social network, and the like. Thus, the interaction can include not only interactions occurring at the client 128, but also interactions or events associated with one or more users of the client 128.

From operation 402, the method 400 proceeds to operation 404, wherein the task engine 122 obtains the SN data 120 from the SN server 116. Although only one SN server 116 is illustrated in FIG. 1, it should be understood that the SN data 120 can relate to two or more social networks.

As explained above with reference to FIG. 1, the SN data 120 includes data indicating one or more members of one or more social networks, as well as data corresponding to the social networks. According to an exemplary embodiment, the SN data 120 corresponds to one or more social networks associated with a user of the client 128. The SN data 120 indicates not only members of the social network associated with the user, but also comments, multimedia content, links, photographs, applications, biographic information, and the like, associated with the members of the social networks. According to various embodiments, the SN data 120 indicates tasks or applications used by one or more members of a social network associated with the user of the client 128.

The SN data 120 is used by the task engine 122 to search for tasks that are expected to be of interest to the user of the client 128, in light of the SN data 120 and/or the contextual data 126. For example, the task engine 122 can inform a user of the client 128 that a social network connection has used a particular task. On the basis of this usage, the task engine 122 can infer that the user of the client 128 will be interested in using the same task. In some embodiments, ratings or reviews of tasks can be used to identify tasks or applications that members of a user's social network have enjoyed or found useful. Thus, the task engine 122 can use the SN data 120 to identify relevant tasks to the user of the client 128.

In implementations in which the task engine 122 depends upon the SN data 120 as well as the contextual data 126, the task engine 122 can identify categories or types of tasks that may be relevant to activity at the client 128, and can rank or order the tasks according to ratings, reviews, usage data, and the like, of the tasks by members of the user's social network. Thus, the relevant tasks 140 identified by the task engine 122 can be not only relevant, but further can be expected to be enjoyable and/or useful to the user of the client 128.

From operation 404, the method 400 proceeds to operation 406, wherein the task engine 122 determines one or more tasks that are relevant to the SN data 120. It should be understood that the task engine 122 can be configured to search or query the task data 112 based upon the contextual data 126 and the SN data 120. Thus, it should be understood that the method 400 can include the functionality of the task engine 122 described above with reference to operation 304 in addition to the functionality described with regard to operation 404. The method 400 ends at operation 408.

Turning now to FIG. 5, a method 500 for packaging and providing the relevant tasks 140 to a client 128, according to an exemplary embodiment. For purposes of illustration, and not limitation, the method 500 is described as being performed by the task engine 122. This embodiment is exemplary, and should not be construed as being limiting in any way. As explained above, the functions of the task engine 122 can be provided by one or more stand-alone device and/or by hardware and/or software associated with other devices. In some embodiments, the functionality of the task engine 122 is provided by the operating system 130 and/or by execution of one or more application programs 132 by the client 128.

The method 500 begins at operation 502, wherein the task engine 122 determines how to provide the relevant tasks 140 to the client 128. In particular, the task engine 122 can first determine if the relevant tasks 140 should be presented for the client 128 or if the relevant tasks 140 should be provided to the user in the background or otherwise without explicitly disclosing the relevant tasks 140 to the user of the client 128. This determination can be based upon a number of factors and/or variables including, but not limited to, the types of activities occurring at the client 128, the types of tasks represented by the relevant tasks 140, whether the tasks are designed to run in the background, and the like.

From operation 502, the method 500 proceeds to operation 504, wherein the task engine 122 determines an advertising and/or ranking scheme for the relevant tasks 140. As mentioned above, the ranking scheme for the relevant tasks 140 can be based upon the contextual data 126 and/or the SN data 120, as well as other factors. Additionally, the task engine 122 can determine the ranking scheme for the tasks based upon usage of the tasks by other users.

For example, the task engine 122, or other devices and/or nodes such as search engines, data collection devices, and the like, can monitor usage of the applications and/or tasks over time. The task data 112 can store not only descriptive information associated with the tasks, but also statistics or other information indicating usage of the tasks, searching or application-usage activity before and after the tasks were used, numbers of task and application uses, and other information. In some embodiments, for example, the relative frequency with which a user uses a first task and then switches to a second, similar task can be tracked and may indicate that the first task was not as useful as the second task. For example, if a user searched for image editing applications and began working with a first image editing task before switching to a second image editing task, the task engine 122 or other node may infer that the first image editing task was not as useful or enjoyable as the second image editing task. This example is illustrative, and should not be construed as being limiting in any way.

Other task and application usage data can be tracked to determine the popularity and/or relevance of applications and tasks. For example, the number of times a particular application or task is searched for by name can be logged by a search engine and may indicate a relative popularity of that application or task. Similarly, entities associated with applications and/or tasks can pay to have their applications or tasks ranked higher by the task engine 122. For example, a vendor may pay to have their application ranked higher than a competitor for a number of searches, regardless of other metrics or data tracked such as popularity, effectiveness, and the like.

Furthermore, the task engine 122 can determine if advertising should be displayed with the tasks. For example, entities or companies may pay to have specific tasks listed first or at an elevated level in search results for searches related to the tasks. For example, a company may pay a charge to have an image editing task listed near the top of search results for queries related to image editing. Similarly, entities or companies may pay to have advertising for their tasks to be listed or advertised on results pages relating to searches related to their tasks.

Although not illustrated in FIG. 5, it should be understood that the task engine 122 also can generate microcharge functionality associated with the tasks. For example, if a user clicks on a link or advertising associated with a particular task, the entity providing the search functionality and/or ranking and advertising functionality can track the click and generate a charge for submission to the entity. In some embodiments, the charge is a microcharge, for example, a charge on the order of portions of a cent, cents, and/or dollars. The microcharges can be tracked and billed according to any desired schedules and/or intervals, if desired.

From operation 504, the method 500 proceeds to operation 506, wherein the task engine 122 determines if one or more user interfaces (“UIs”) should be generated to provide the relevant tasks 140 to the client 128. In some circumstances, the relevant tasks 140 can include or be associated with particular UIs. For example, a task for cropping an image can be associated with a UI for displaying the image, displaying a frame or overlay corresponding the bounds of the cropping operation, options for accepting the bounds at a particular time, and the like. In another example, a telephone or VoIP dialing task can implicitly require generation of an alphanumeric keypad for dialing or entering phone numbers or addresses and/or a field for displaying dialed or entered numbers or addresses. In these, as well as other contemplated implementations, the task engine 122 may determine that one or more UI elements should be generated and presented with the relevant tasks 140.

If the task engine 122 determines that a UI or UI element should be generated, the method 500 proceeds to operation 508, wherein the task engine 122 generates or retrieves one or more UIs for the relevant tasks 140. The UIs can be stored in any accessible data storage location. The locations and/or identifies of the UIs associated with a particular task can be stored with the task data 112, if desired.

From operation 508, or if the task engine 122 determines in operation 506 that no UI should be generated, the method 500 proceeds to operation 510, wherein the task engine 122 presents the relevant tasks 140 to the client 128. In some embodiments, the relevant tasks 140 are presented to the client 128 as user-viewable ‘widgets,’ or the like, inside a browser, a remotely executed application, and/or a locally executed application. In other embodiments, the relevant tasks 140 can be presented in pages or applications, wherein the relevant tasks 140 are executed or provided behind the scenes by one or more task components. In some embodiments, the task engine 122 provides links or addresses for accessing the functionality of the relevant tasks 140. In yet other embodiments, the task engine 122 presents executable code for providing the functionality associated with the relevant tasks 140.

Furthermore, in some embodiments, the task engine 122 provides a number of relevant tasks 140. For example, the task engine 122 can be configured to build a pipeline of tasks, and provides the client 128 with instructions for accessing the starting point of the pipeline. For example, a particular task may explicitly or implicitly require execution of a number of tasks. The task engine 122 can determine what tasks are required, the order in which the tasks should be provided or completed, and can generate a work flow for the task. This work flow, or pipeline, can be provided to the client 128 with instructions for beginning the workflow. The method 500 ends at operation 512.

According to some embodiments, users or entities can build custom compilations of tasks. For example, users may build compilations of tasks that the users find useful or enjoy using. These tasks may be made available to the user whenever the user is in communication with the task engine 122. The task engine 122 may recognize that the user is connected to the task engine 122 based upon reading one or more cookies, by a login process executed by a device or node in communication with the task engine 122, by a token, an explicit indication from the user, and/or the like.

Similarly, the concepts and technologies disclosed herein can be used to compile custom applications. For example, a user may wish to build a custom travel application based upon various travel tasks. Thus, the user may include airplane ticket searching tasks from a first source, car rental searches and booking tasks from a second source, and hotel searches and booking from a third source. When the user uses the custom application to build a vacation or other trip, the different aspects of the planning can be provided by the selected sources in a seamless manner, particularly in view of the fact that the tasks can be decoupled from particular UIs. Thus, the custom application can be provided to the user in a seamless manner, allowing the user to conveniently access the desired tasks from the desired sources. This example is illustrative, and should not be construed as being limiting in any way.

Tasks associated with the user can be persisted in the background for the user, if desired, and/or made available to the user at any time. Thus, for example, the task engine 122 can provide chatting or communication services that run in the background unless or until communications are received. Additionally, the task engine 122 can be configured to check for task updates, or to command the discovery engine 108 to check for task updates. If a task is updated by a developer or other entity, the discovery engine 108 can update the task data 112 and/or the task engine 112, thereby ensuring that the tasks made available to the client 128 are the most current version available. The task engine 112 and/or the discovery engine 108 can update the tasks according to a regular schedule, upon release of a new version, and the like. According to some embodiments, users can access one or more versions of the tasks, according to user preferences, system requirements, capabilities, and limitations, user needs, and the like.

According to some embodiments, the concepts and technologies disclosed herein can be used to support advanced notions of application and task purchasing. In particular, in some embodiments, application developers sell or make available limited-functionality versions of their software and/or applications. Users can access additional application tasks designed to work with and/or supplement the limited-functionality versions of the software and/or applications. Thus, for example, a user may purchase a limited-functionality version of image editing software that supports, for example, viewing images, selecting and copying portions of images, saving images, cropping images, and the like. The user can access additional tasks such as color balancing tasks, red-eye correction tasks, blemish removal tasks, blur and sharpness adjustment tasks, and the like. In some embodiments, the task engine 122 receives the contextual data 126, and contextual data 126 indicates that the user has the limited-functionality version of the software. This information is used by the task engine 122 to identify and suggest additional tasks that are believed to be relevant to the user.

Similarly, the concepts and technologies disclosed herein can be used to support advanced notions of application and/or task presentation and activation. As used herein, “activation” refers to accessing, executing, rendering data associated with, and/or otherwise making use of one or more tasks by way of the client 128. It will be appreciated that by supporting searching for, identifying, and presenting relevant tasks 140 instead of merely presenting entire application packages, the concepts and technologies disclosed herein can be used to ease the manner in which context associated with searches and/or activity is identified and with which the relevant tasks 140 relating to the context are presented and activated by the client 128.

More particularly, a search and/or contextual information may reflect activities at the client 128 such as “compose an email,” “schedule an appointment,” “remove red-eye from a photo,” and the like, as explained above, instead of or in addition to identifying broad contextual or usage information such as “messaging,” “calendaring,” “image processing,” and the like. Thus, the task engine 122 can be configured to identify the relevant tasks 140, and to present the relevant tasks 140 at the client 128 in a manner that enables the client 128 to easily activate one or more of the relevant tasks 140. Because narrow definitions of context and/or usage are used to identify the relevant tasks 140, some of the relevant tasks 140 may be extremely relevant to the activity occurring at the client 128.

In some embodiments, the use of the relevant tasks 140 by or via the client 128 can be simplified relative to activating or otherwise accessing applications. In particular, some embodiments enable the client 128 to access the relevant tasks 140 without accessing one or more applications with which the relevant tasks 140 are associated, without searching for the relevant tasks 140 once the applications are activated or accessed, and/or without performing other intermediate steps that may be required to access the relevant tasks 140 via accessing or activating applications or application packages. Although not described herein in detail, it should be appreciated that the task engine 122 may use the SN data 120 instead of, or in addition to, the contextual data 126 to identify, present, and/or support easy activation of the relevant tasks 140.

In another embodiment, a limited-functionality version of a mail program can be later supplemented with tasks for message or attachment translation, message or attachment encryption, message or attachment spell checking, and the like. These tasks can be made available for all messages sent or received via the mail program, and updated as explained above. This embodiment is exemplary, and should not be construed as being limiting in any way.

According to various embodiments, the tasks can be provided to the client 128 or other devices or nodes in accordance with a push model and/or a pull model. More particularly, it will be understood that the task functionality can be pushed to the client 128 and/or pulled by the client 128. For example, the activity and/or context of activities at the client 128 can be analyzed by the task engine 122. The task engine 122 can identify the relevant tasks 140 and push the relevant tasks 140 to the client 128. Additionally, or alternatively, the client 128 can request particular functionality or recognize that particular functionality is desired or needed. Thus, the client 128 may pull the desired relevant tasks 140, for example, by requesting a particular task or functionality from the task engine 122.

According to another embodiment, the concepts and technologies disclosed herein can be used to provide task and/or application comparisons for users, and user selection of task providers. For example, a particular task such as video editing may be provided by a number of task providers. Some users may be unable to distinguish between the tasks based solely upon descriptions associated with the tasks. These users, however, may be able to distinguish between results of the tasks as provided by the various providers. As such, in some embodiments, the client 128 can access similar or even identical tasks provided by one or more providers and/or one or more versions of the tasks. In the example of video editing, several tasks for video editing can be provided to the client 128, and the user associated with the client 128 can select the preferred task based upon results, ease of use, cost, and/or the like.

According to other embodiments, the task engine 122 is configured to identify related tasks and/or data that may be relevant to related tasks. For example, if a user accesses travel tools to purchase hotel accommodations, rental cars, and/or airplane tickets, the task engine 122 can determine that restaurant and/or entertainment services may be useful or relevant to the user. As such, the task engine 122 can suggest or provide to the client 128 access to restaurant reviews, maps, reservations, and the like, as well as entertainment services such as movie tickets, museum tickets, and the like. These embodiments are exemplary, and should not be construed as being limiting in any way.

According to another embodiment, the SN data 120 is used to prompt the client 128 to access particular functionality. For example, the task engine 122 may recognize, by analysis of the SN data 120, that a colleague of the user has generated or stored an online document that may be relevant to the user of the client 128. As such, the task engine 122 can inform the user of the client that the document is available and/or suggest that the client 128 collaborate with the colleague regarding the document. This embodiment is exemplary and should not be construed as being limiting.

As explained above, the task engine 122 can access information generated by one or more search engines (not illustrated). For example, the task engine 122 can access page ranking and similar functionality for ranking or ordering the relevant tasks 140. The task engine 122 also can track metrics for task developers or providers. For example, the task engine 122 can track usage and ranking statistics and/or can use the usage and ranking statistics to price advertising associated with the tasks, placement of the tasks in search results, and the like. Additionally, the task engine 122 can report these and other usage statistics to the task developers and/or use the statistics to generate upsell opportunities with the task developers. For example, the task engine 122 or entities associated therewith can sell task entry points to task developers, wherein the task entry points are provided to searchers as search results for particular queries.

The task engine 122 also can recognize or maintain blacklists of tasks. Tasks can be blacklisted on the basis of malicious activity, inaccurate or misleading descriptions, and the like. Blacklisted tasks, even if returned by the search application 124 as being relevant to particular activities as the client 128, can be withheld from the client 128, blocked by the task engine 122, generate warnings or reports to the client 128, combinations thereof, and the like. According to some embodiments, the task engine 122 accesses virus alerts and/or other blacklists to identify malicious tasks. Additionally, users can report inappropriate tasks, tasks with inaccurate or misleading descriptions, and the like, to the task engine 122.

According to various embodiments, the tasks can be provided to the user without any dedicated UI. For example, tasks may be made available via public or private APIs for programmatic use by other executable code. Because the tasks can be provided to the client 128 outside of a dedicated UI, the tasks can be accessed or utilized by any type and/or any combination of clients 128. For example, a user may access a particular task with a desktop computer, a laptop computer, a smartphone, a netbook computer, and/or any other device capable of accessing the tasks. Thus, the concepts and technologies disclosed herein allow and/or enable universal access to the functionality of the tasks via any capable device.

Additionally, decoupling the tasks from dedicated or standard UIs can enable users to interact with the tasks in new or simplified manners. For example, instead of accessing application functionality through dedicated UIs using keyboards, mice, and the like, users can access the tasks with non-screen UIs such as interactive voice response (“IVR”) systems, voice commands, speech to text input devices, touch screen devices, and the like. Thus, for example, embodiments support allowing a user to control image editing tasks, or any other tasks, using voice commands or other non-traditional UIs.

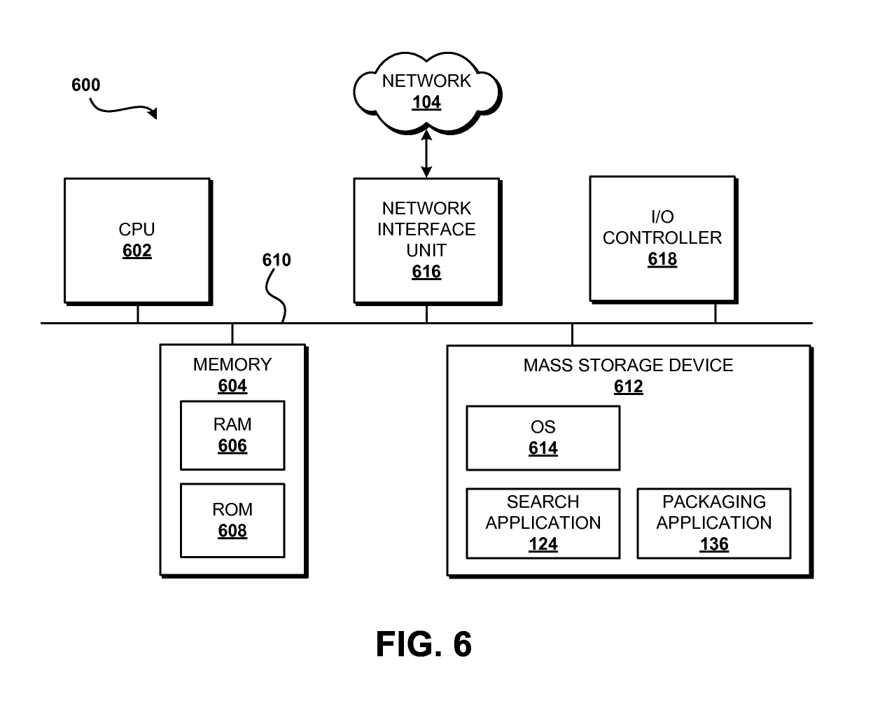

FIG. 6 illustrates an exemplary computer architecture 600 for a device capable of executing the software components described herein for contextual and task-focused computing. Thus, the computer architecture 600 illustrated in FIG. 6 illustrates an architecture for a server computer, mobile phone, a PDA, a smart phone, a server computer, a desktop computer, a netbook computer, a tablet computer, and/or a laptop computer, for example the task engine 122. The computer architecture 600 may be utilized to execute any aspects of the software components presented herein.

The computer architecture 600 illustrated in FIG. 6 includes a central processing unit 602 (“CPU”), a system memory 604, including a random access memory 606 (“RAM”) and a read-only memory (“ROM”) 608, and a system bus 610 that couples the memory 604 to the CPU 602. A basic input/output system containing the basic routines that help to transfer information between elements within the computer architecture 600, such as during startup, is stored in the ROM 608. The computer architecture 600 further includes a mass storage device 612 for storing the operating system 614, the search application 124, and the packaging application 138. As explained above, the task engine 122 can be configured to provide the functionality described herein with respect to the discovery engine 108. As such, although not shown in FIG. 6, the mass storage device 612 also can be configured to store one or more applications for providing the functionality of the discovery engine 108, if desired.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a hard disk or CD-ROM drive, it should be appreciated by those skilled in the art that computer-readable media can be any available computer storage media that can be accessed by the computer architecture 600.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes of this specification and the claims, the phrase “computer-readable storage medium” and variations thereof, does not include communication media.

According to various embodiments, the computer architecture 600 may operate in a networked environment using logical connections to remote computers through a network such as the network 104. The computer architecture 600 may connect to the network 104 through a network interface unit 616 connected to the bus 610. It should be appreciated that the network interface unit 616 also may be utilized to connect to other types of networks and remote computer systems, for example, the client device 128. The computer architecture 600 also may include an input/output controller 618 for receiving and processing input from a number of other devices, including a keyboard, mouse, or electronic stylus (not shown in FIG. 6). Similarly, the input/output controller 618 may provide output to a display screen, a printer, or other type of output device (also not shown in FIG. 6).

It should be appreciated that the software components described herein may, when loaded into the CPU 602 and executed, transform the CPU 602 and the overall computer architecture 600 from a general-purpose computing system into a special-purpose computing system customized to facilitate the functionality presented herein. The CPU 602 may be constructed from any number of transistors or other discrete circuit elements, which may individually or collectively assume any number of states. More specifically, the CPU 602 may operate as a finite-state machine, in response to executable instructions contained within the software modules disclosed herein. These computer-executable instructions may transform the CPU 602 by specifying how the CPU 602 transitions between states, thereby transforming the transistors or other discrete hardware elements constituting the CPU 602.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 may include other types of computing devices, including hand-held computers, embedded computer systems, personal digital assistants, and other types of computing devices known to those skilled in the art. It is also contemplated that the computer architecture 600 may not include all of the components shown in FIG. 6, may include other components that are not explicitly shown in FIG. 6, or may utilize an architecture completely different than that shown in FIG. 6.

Based on the foregoing, it should be appreciated that technologies for contextual and task-focused computing have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method for task-focused computing, the computer-implemented method comprising performing computer-implemented operations for:
obtaining application data, the application data corresponding to an application;
identifying a task associated with the application;
generating task data describing the task associated with the application; and
storing the task data in a searchable format, the task data being stored at a data storage device.

2. The method of claim 1, wherein the task data describes at least one function performed by the application.

3. The method of claim 1, wherein collecting the application data comprises:
discovering, using a discovery engine, the application; and
obtaining the application data from the device hosting the application.

4. The method of claim 1, further comprising:
detecting an interaction at one or more clients;
obtaining contextual data from the one or more clients, the contextual data describing the interaction at the one or more clients;
determining one or more relevant tasks based upon the contextual data, the relevant tasks comprising one or more tasks that are expected to be relevant to the client based upon the interaction detected at the client; and
providing the one or more relevant tasks to the one or more clients for activation by the one or more clients without requiring activating of one or more applications associated with the one or more relevant tasks.

5. The method of claim 1, further comprising:
detecting an interaction at one or more clients;
obtaining social networking data associated with a social networking service;
determining one or more relevant tasks based upon the social networking data; and
providing the one or more relevant tasks to the one or more clients for activation by the one or more clients.

6. The method of claim 1, further comprising:
detecting an interaction at one or more clients;
obtaining social networking data associated with a social networking service;
obtaining contextual data from the one or more clients, the contextual data describing the interaction at the one or more clients; and
determining one or more relevant tasks based upon at least one of the social networking data or the contextual data.

7. The method of claim 6, further comprising determining an advertising scheme for the relevant tasks, the advertising scheme comprising data indicating if advertising should be provided to the one or more clients with the relevant tasks.

8. The method of claim 6, further comprising determining a ranking scheme for the relevant tasks, the ranking scheme comprising an order in which the relevant tasks are presented to the one or more clients.

9. The method of claim 6, further comprising:
determining whether to generate a user interface associated with one or more of the relevant tasks; and
generating the user interface, in response to determining that the user interface should be generated.

10. The method of claim 5, wherein the social networking data describes a social network associated with a user of the client, and wherein the social networking data indicates one or more tasks accessed by a member of the social network.

11. The method of claim 9, further comprising providing at least one of the relevant tasks outside of a dedicated user interface, in response to determining that the user interface should not be generated.

12. The method of claim 8, wherein determining the ranking scheme comprises at least one of:
decreasing the rank of a relevant task selected from the at least one of the relevant tasks based upon usage of the relevant task; or
increasing the rank of the relevant task based upon the usage of the relevant task.

13. A computer-implemented method for task-focused computing, the computer-implemented method comprising performing computer-implemented operations for:
discovering, at a discovery engine, an application hosted by a server computer;
obtaining application data corresponding to the application, the application data comprising data describing functionality associated with the application;
identifying a task associated with the application, the task corresponding to at least one aspect of the functionality associated with the application;
generating task data describing the task associated with the application;
indexing the task data based upon a category or type of task corresponding to the task; and
storing the task data in a searchable format, the task data being stored at a data storage device.

14. The method of claim 13, further comprising:
detecting an interaction at a client;
obtaining social networking data associated with a social networking service;
obtaining contextual data associated with the client, the contextual data describing the interaction at the client and indicating at least one of a type of activity associated with the interaction or a type of file being accessed at the client; and
determining one or more relevant tasks based upon at least one of the social networking data or the contextual data.

15. The method of claim 14, further comprising:
determining an advertising scheme for the relevant tasks, the advertising scheme indicating if advertising should be provided to the client with the relevant tasks; and
determining a ranking scheme for the relevant tasks, the ranking scheme comprising an order in which the relevant tasks are presented to the client.

16. The method of claim 13, further comprising:
determining whether to generate a user interface associated with one or more of the relevant tasks;
generating the user interface, in response to determining that the user interface should be generated; and
providing at least one of the relevant tasks outside of a dedicated user interface, in response to determining that the user interface should not be generated.

17. The method of claim 14, wherein the social networking data describes a social network associated with a user of the client, and wherein the social networking data indicates one or more tasks accessed by a member of the social network.

18. The method of claim 15, wherein determining the ranking scheme comprises at least one of:
decreasing the rank of a relevant task selected from the at least one of the relevant tasks based upon usage of the relevant task by a member of the social network; or
increasing the rank of the relevant task based upon the usage of the relevant task by the member of the social network.

19. A computer-readable storage medium having computer readable instructions stored thereupon that, when executed by a computer, cause the computer to:
provide to a task engine data indicating an interaction at a client, the interaction comprising at least one of an activity occurring at the client, a past activity occurring at the client, or a file being used at the client;
expose contextual data to the task engine the contextual data describing the interaction at the client and indicating at least one of a type of activity associated with the interaction or a type of file being accessed by the client; and
receive, from the task engine, data indicating one or more relevant tasks based upon at least one of social networking data or the contextual data, the social networking data being associated with a social networking service, describing a social network associated with a user of the client, and indicating one or more tasks accessed by a member of the social network.

20. The computer-readable storage medium of claim 19, further comprising instructions that, when executed by the computer, cause the computer to:
receive the relevant tasks from the task engine in accordance with an advertising scheme for the relevant tasks and a ranking scheme for the relevant tasks, the advertising scheme being determined by the task engine and indicating if advertising should be provided to the client with the relevant tasks, and the ranking scheme comprising an order in which the relevant tasks are presented to the client;
receiving the relevant tasks with a generated user interface associated with one or more of the relevant tasks in response to a determination by the task engine that the user interface should be generated; and
receiving at least one of the relevant tasks outside of a dedicated user interface, in response to a determination by the task engine that the user interface should not be generated.
